(19) United States
(12) Patent Application Publication
(10) Pub. No.: US 2026/0129361 A1
(43) Pub. Date: May 7, 2026

(54) AI-Based Multi-Band Loudspeaker Control

(71) Applicant: Samsung Electronics Co., Ltd., Suwon-si (KR)

(72) Inventors: Yuan Li, Los Angeles, CA (US); Pascal Brunet, Paris (FR)

(21) Appl. No.: 18/939,215

(22) Filed: Nov. 6, 2024

(51) Int. Cl. H04R 3/04; G06F 3/16; H04R 29/00

(52) U.S. Cl. CPC H04R 3/04; G06F 3/16; H04R 29/001

(57) ABSTRACT

In one embodiment, a method includes filtering an audio signal into multiple frequency bands including a high-frequency band and a low-frequency band; and converting the audio signal in the high-frequency band to a target sound pressure, and converting the audio signal in the low-frequency band to a target speaker displacement. The method further includes predicting, by a trained HF neural network and based on the target sound pressure corresponding to the audio signal in the high-frequency band, a first output voltage for a playing the audio signal by a loudspeaker; predicting, by a trained LF neural network and based on the target speaker displacement corresponding to the audio signal in the low-frequency band, a second output voltage for playing the audio signal by the loudspeaker; and combining the first and second output voltages to obtain a final output voltage for playing the audio signal by the loudspeaker.

### TECHNICAL FIELD

This application generally relates to AI-based multi-band loudspeaker control.

### BACKGROUND

A loudspeaker converts an electrical audio signal into a corresponding sound.

Loudspeakers can be used for playing music, listening to audio content corresponding to video content (e.g., audio of a TV show or a movie), etc. Loudspeakers can include one or more speakers in an entertainment system or one or more speakers integrated into another electronic device (e.g., speakers in a smartphone, tablet, personal computer, wearable device, headphones such as earbuds, etc.).

A loudspeaker includes a linear electric motor connected to a diaphragm. The loudspeaker uses voltage to move the diaphragm and thus create acoustic waves that produce sounds. The exact relationship between the sound reproduced and the voltage used to drive the loudspeaker is complex, difficult to model, and is specific to the loudspeaker and its enclosure. Furthermore, that relationship is nonlinear and time-varying, and can be particularly complex for audio that includes a broad spectrum of frequencies, from low bass to high treble.

### BRIEF DESCRIPTION OF THE DRAWINGS

FIG. 1 illustrates an example method for determining the control voltage of a loudspeaker.

FIG. 2 illustrates speaker displacement and sound pressure as a function of frequency.

FIG. 3 illustrates an example implementation of the method of FIG. 1.

FIG. 4 illustrates an example computing system.

### DESCRIPTION OF EXAMPLE EMBODIMENTS

Actual solutions for nonlinear control of loudspeakers are complex, difficult to implement, and to setup. Their precision is limited due to incomplete physical models of an audio system, and therefore such models do not completely capture the complexity of that system. The parameters of an audio system can be frequency dependent, time-varying, and nonlinear, making them difficult to measure, model, and estimate. This is particularly true for speakers designed to cover a broad spectrum of frequencies, from low bass (e.g., 20 Hz) to high treble (e.g., 20 kHz), although it is also true for loudspeakers that play audio in a narrower frequency range.

For example, the elastic properties (e.g., stiffness) of a surround (the flexible material that attaches the speaker diaphragm to the speaker basket) varies non-linearly as a function of the diaphragm's excursion, and the stiffness of the surround affects the sound produced by the diaphragm in response to a control voltage. As another example, the efficiency of a loudspeaker motor (i.e. how well the motor converts input electrical power to mechanical power) also varies non-linearly as a function of the diaphragm's excursion, and a motor's efficiency affects the sound produced by a loudspeaker in response to an input control voltage. As another example, the inductance of the voice coil varies as a function of the input current, and the inductance of the voice coil affects the sound produced by a loudspeaker in response to an input control voltage. These are just a few examples of the complex, non-linear behavior of a real loudspeaker, which makes it difficult to precisely predict the output sound of a real loudspeaker in response to an input voltage.

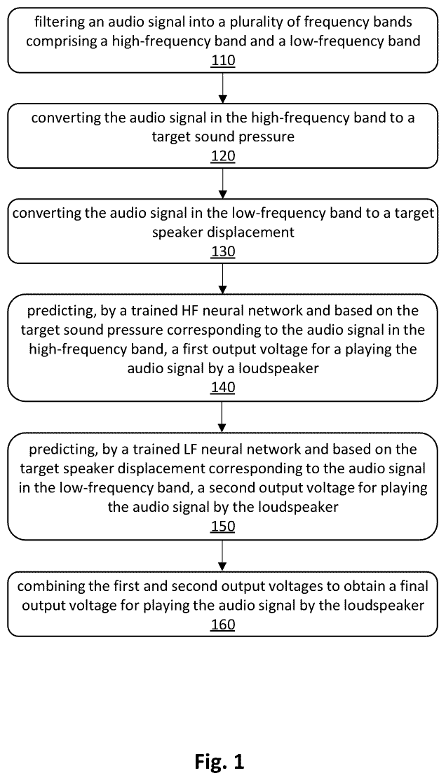

The techniques of this disclosure account for such nonlinearities and other complexities by using parallel neural networks to determine a control voltage for a loudspeaker based on the input audio signal that the speaker will play. FIG. 1 illustrates an example method for determining the control voltage of a loudspeaker. Step 110 of the example method of FIG. 1 includes filtering an audio signal into multiple frequency bands that include (1) a high-frequency band and (2) a low-frequency band. For example, a crossover filter may be used to filter an audio signal u(t) (an input voltage) into multiple frequency bands. In particular embodiments, the frequency bands may be a low-frequency band and a high-frequency band. In particular embodiments, the low frequency band may include frequencies below at least 1 kHz, and the high-frequency band may include frequencies above 700 kHz; however, these values may be specific to the driver used in a particular loudspeaker (e.g. may depend on the driver's size). As described more fully below, the multiple frequency bands may include more than two frequency bands.

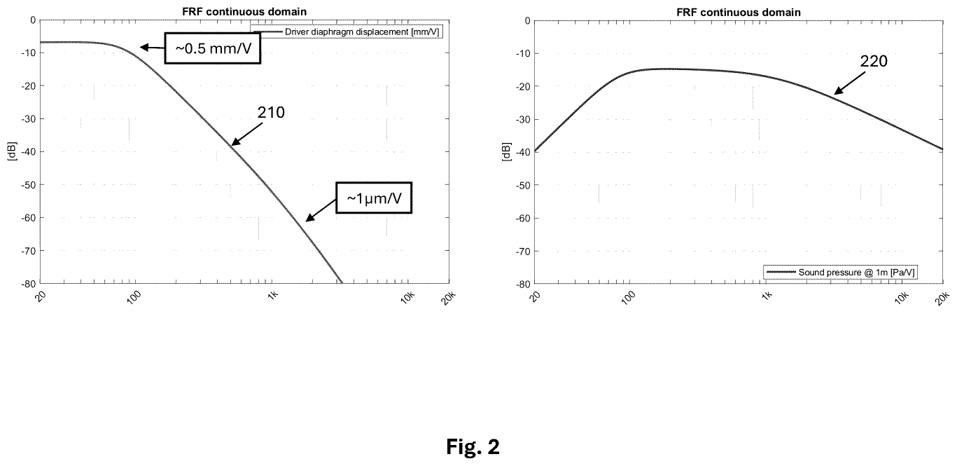

U.S. Pat. No. 11,356,773 describes an approach to determining loudspeaker control voltage based on inputting speaker displacement values to a trained neural network. However, as illustrated in FIG. 2, displacement of a full-range driver rapidly falls off above a certain frequency threshold, and that threshold depends on the particular parameters of the loudspeaker. For example, curve 210 of FIG. 2 illustrates driver displacement as a function of input frequency. In the example of FIG. 2, at around 800 Hz the output falls to −50 dB, and frequencies above 1 kHz result in a displacement of only about 1 μm/V. Displacement values this small have small signal-to-noise (SNR) ratios when it is recorded even using a high quality laser. The higher the ratio, the better the signal quality. Therefore using such displacement data for ML-model training and inference can result in inaccurate voltage determinations. However, as illustrated in FIG. 2, displacement and displacement SNR are relatively high for lower frequencies. In practice, the acceptable dB values below which displacement becomes too small depends on the noise in the system; for instance, a noisy system may have poor quality when using frequencies associated with displacement values up to −30 dB, while a more robust system may have suitable quality when using frequencies associated with displacement values up to −50 dB.

Curve 220 of FIG. 2 illustrates sound pressure as a function of frequency for an example loudspeaker. As illustrated by curve 220, and in contrast to displacements, sound-pressure values do not fall off at higher frequencies, and in fact have good SNR above relatively low frequencies.

Step 120 of the example method of FIG. 1 includes converting the audio signal in the high-frequency band to a target sound pressure, and step 130 includes converting the audio signal in the low-frequency band to a target speaker displacement. For example, linear filtering may be used to tune the high-frequency band response to the system, thereby generating the target sound pressures (i.e., the sound pressures that should result from the loudspeaker playing the high-frequency content in the input audio signal). Linear filtering may likewise be used in step 130 to tune the low-frequency band and output target displacements that should result from the low-frequency content in the input audio signal.

In particular embodiments, step 120 and 130 can include ensuring that the audio system stays within its own physical limits (e.g., that sound pressures and displacements don't exceed what a loudspeaker is physically capable of providing). For example, the system may be driven to its maximum level at various frequencies, and the corresponding sound pressures and displacements may be recorded to determine the system's limits. In particular embodiments, target displacements may be determined by applying a 2^{nd} order low pass filter to a voltage signal u (t), and sound pressures may be determined by applying a 3^{rd} order bandpass filter to a voltage signal u (t), although this disclosure contemplates that any suitable approach for modeling target sound pressures and displacement may be used.

Step 140 of the example method of FIG. 1 includes predicting, by a trained HF (high frequency) neural network and based on the sound pressure corresponding to the audio signal in the high-frequency band, a first output voltage for a playing the audio signal by a loudspeaker. As described above, displacement can be used as a quality signal for predicting a control voltage for relatively low frequencies, but the displacement signal gets noisy at higher frequencies. Therefore, the example method of FIG. 1 uses sound pressure as the marker for the relatively high frequencies, therefore achieving accurate predicted control voltages for those signals.

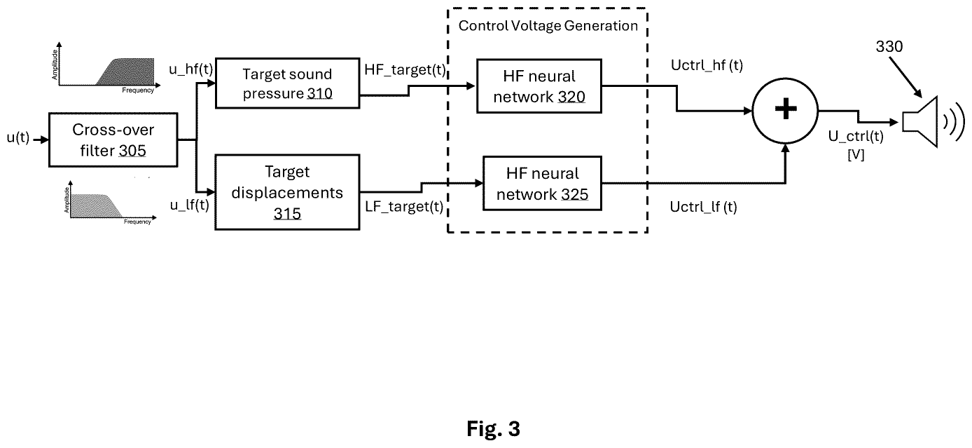

FIG. 3 illustrates an example implementation of the method of FIG. 1. FIG. 3 illustrates HF neural network 320, which takes as its input the target sound-pressures 310 (HF_target(t)) that the loudspeaker should create from the high-frequency content in the original audio signal (u(t)) after filtering by crossover filter 305. During inference, HF neural network 320 outputs a predicted control voltage (Uctrl_hf(t)) for operating loudspeaker 330 to achieve these target sound pressures. Thus, this predicted HF control voltage is the voltage that will accurately reproduce the input audio signal (as identified by the target sound pressures) that is in the high frequency band.

HF neural network 320 may be trained using supervised training. In particular embodiments, to generate training pairs, a known input voltage corresponding to signals in the high-frequency band may be supplied to a loudspeaker, and the sound pressure produced by the loudspeaker in response to the voltage is measured, for example by a near-field microphone. The input voltage is then used as the ground truth, and pairs of ground-truth control voltages and corresponding actual sound pressures output by the loudspeaker may then be used to train HF neural network 320. To do so, recorded sound pressure values are input to HF neural network 320, which is trained to predict the corresponding ground-truth control voltage that resulted in the generated sound pressures. Thus, after training and during inference, HF neural network 320 receives target sound pressures, as described above, and predicts the actual control voltages that will cause the particular loudspeaker to generate those target sound pressures. The input to HF neural network 320 may be the sound pressure values themselves, and/or may be features derived from the sound pressure values, such as a double integration of sound-pressure values.

Step 150 of the example method of FIG. 1 includes predicting, by a trained LF neural network and based on the speaker displacement corresponding to the audio signal in the low-frequency band, a second output voltage for playing the audio signal by the loudspeaker. As described above, displacement can be used as a quality signal for predicting a control voltage for relatively low frequencies, but loses accuracy at higher frequencies. Therefore, the example method of FIG. 1 uses sound pressure as the marker for the relatively high frequencies and uses displacement as the marker for relatively low frequencies, resulting in accurate acoustic reproduction by the loudspeaker.

FIG. 3 illustrates LF neural network 325, which takes as its input target displacements 315 (LF_target(t)) that the loudspeaker should create from the low-frequency content in the audio signal. During inference, LF neural network 325 outputs a predicted control voltage (Uctrl_lf(t)) for operating loudspeaker 330 to achieve these target displacements. Thus, this predicted LF control voltage is the voltage that will accurately reproduce the input audio signal (as identified by the target displacements) that is in the low frequency band. In particular embodiments, such as illustrated in FIG. 3, HF neural network 320 and LF neural network 325 work in parallel to predict their respective output control voltages. However, in other embodiments one of the output control voltages may be predicted before the other (e.g., the first control voltage may be predicted first, or the second control voltage may be predicted first).

LF neural network 325 is trained separately from HF neural network 320. LF neural network may be trained using supervised training. In particular embodiments, to generate training pairs, a known input voltage corresponding to signals in the low frequency band may be supplied to a loudspeaker, and the displacement produced by the loudspeaker in response to this voltage is measured, for example by a laser. The input voltage is then used as the ground truth, and pairs of ground-truth control voltages and corresponding actual displacements output by the loudspeaker may then be used to train LF neural network 325. To do so, recorded displacement values are input to LF neural network 325, which is trained to predict the corresponding ground-truth control voltage that resulted in the generated displacements. Thus, after training and during inference, LF neural network 325 receives target displacements, as described above, and predicts the actual control voltages that will cause the particular loudspeaker to generate those target displacements.

In particular embodiments, LF neural network 325 may use a time-delay neural network structure that is similar to feedforward network, except that the input weight has a tap delay line associated with it, allowing the network to have a finite dynamic response to time series input data. In particular embodiments, LF neural network 325 may have two layers (one hidden layer and one input layer) and may use a 15×1 input vector and produce a 1×1 output vector. LF neural network 325 may use 30 neurons and have 480 total weights, illustrating a lightweight example of LF neural network 325 that can be readily deployed on a wide range of loudspeakers and devices containing or controlling loudspeakers (e.g., smartphones, etc.). The input to LF neural network 325 may be the displacement values themselves, and/or may be features derived from the sound pressure values.

Step 160 of the example method of FIG. 1 includes combining the first and second output voltages to obtain a final output voltage for playing the audio signal by the loudspeaker. For instance, as illustrated in the example of FIG. 3, the first and second output voltages may be summed together to arrive at the final output voltage (U_ctrl(t)) for playing the audio signal, although other approaches to combining the predicted output voltages to arrive at the final output voltage may be used. As a result of step 160, the combined first and second output voltages together represent the control voltage that causes loudspeaker 330 to accurately reproduce the input audio, despite the nonlinearities present in loudspeaker 330's audio reproduction.

While the example method of FIG. 1 filters an input audio signal into two frequency bands, this disclosure contemplates that other approaches may filter an input audio signal into more than two frequency bands. In particular embodiments, each frequency band may then have an associated control voltage determined based on that frequency band, and that determination may be made by a neural network or by another technique. Moreover, while the example of FIG. 1 illustrates using a trained AI model to determine the control voltage for the high-frequency band and using a trained AI model to determine the control voltage for the low-frequency band, other embodiments may use a trained AI model for one of those two bands, and may use a different approach for the other band. For example, an input audio signal may be filtered into a high-frequency band and a low-frequency band, and a LF neural network may be used to determine the control voltage for those low-frequency signals, while a non-AI based method (e.g., linear control) may be used to determine the control voltage corresponding to the high-frequency band. In other embodiments, a HF neural network may be used to determine the control voltage for high-frequency signals, based on target sound pressure, while a non-AI method is used to determine the control voltages corresponding to low-frequency signals. In addition, AI models other than a neural network may be used to determine a first or second control voltage, such as an LSTM, Xboost Tree, etc.

The techniques described herein can be implemented in any suitable device that contains or controls one or more loudspeakers, such as smartphones, headphones (including earbuds), TVs, sound bars, etc. Moreover, particular embodiments use lightweight, low-parameter neural networks to predict the control voltages, and such embodiments may be particularly well-suited for small, low power devices or devices with limited digital signal processing. The techniques described herein improve accurate audio reproduction, including by maximizing bass output and loudness while minimizing distortion.

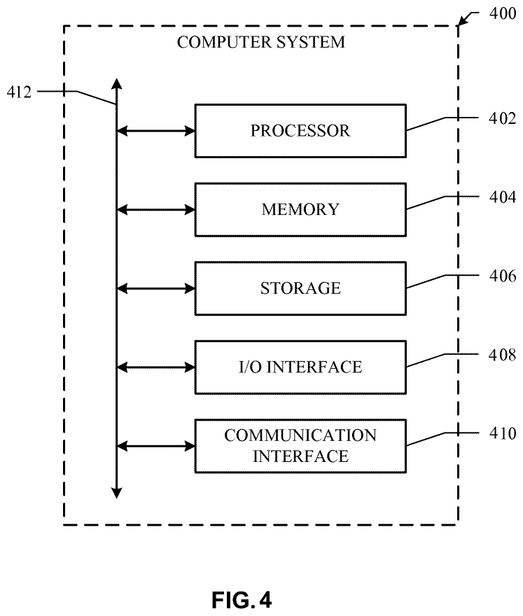

FIG. 4 illustrates an example general-purpose computer system 400. FIG. 4 illustrates the main processors and memory in general-purpose computer system 400 and not the secured hardware portions described above. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
filtering an audio signal into a plurality of frequency bands comprising a high-frequency band and a low-frequency band;
converting the audio signal in the high-frequency band to a target sound pressure;
converting the audio signal in the low-frequency band to a target speaker displacement;
predicting, by a trained HF neural network and based on the target sound pressure corresponding to the audio signal in the high-frequency band, a first output voltage for a playing the audio signal by a loudspeaker;
predicting, by a trained LF neural network and based on the target speaker displacement corresponding to the audio signal in the low-frequency band, a second output voltage for playing the audio signal by the loudspeaker; and
combining the first and second output voltages to obtain a final output voltage for playing the audio signal by the loudspeaker.

2. The method of claim 1, wherein the audio signal is filtered into the high-frequency band and the low-frequency band by a crossover filter.

3. The method of claim 1, wherein combining the first and second output voltages to obtain a final output voltage comprises summing the first and second output voltages.

4. The method of claim 1, wherein the loudspeaker comprises a speaker of a smartphone.

5. The method of claim 1, wherein the loudspeaker comprises a speaker of a headphone.

6. The method of claim 1, wherein the trained HF neural network is trained to predict ground-truth control voltages from input, recorded sound pressures caused by those ground-truth control voltages.

7. The method of claim 1, wherein the trained LF neural network is trained to predict ground-truth control voltages from input, recorded speaker displacements caused by those ground-truth control voltages.

8. One or more non-transitory computer readable storage media storing instructions that are operable when executed to:
filter an audio signal into a plurality of frequency bands comprising a high-frequency band and a low-frequency band;
convert the audio signal in the high-frequency band to a target sound pressure;
convert the audio signal in the low-frequency band to a target speaker displacement;
predict, by a trained HF neural network and based on the target sound pressure corresponding to the audio signal in the high-frequency band, a first output voltage for a playing the audio signal by a loudspeaker;
predict, by a trained LF neural network and based on the target speaker displacement corresponding to the audio signal in the low-frequency band, a second output voltage for playing the audio signal by the loudspeaker; and
combine the first and second output voltages to obtain a final output voltage for playing the audio signal by the loudspeaker.

9. The media of claim 8, wherein combining the first and second output voltages to obtain a final output voltage comprises summing the first and second output voltages.

10. The media of claim 8, wherein the loudspeaker comprises a speaker of a smartphone.

11. The media of claim 8, wherein the loudspeaker comprises a speaker of a headphone.

12. The media of claim 8, wherein the trained HF neural network is trained to predict ground-truth control voltages from input, recorded sound pressures caused by those ground-truth control voltages.

13. The media of claim 8, wherein the trained LF neural network is trained to predict ground-truth control voltages from input, recorded speaker displacements caused by those ground-truth control voltages.

14. A system comprising:
one or more non-transitory computer readable storage media storing instructions; and one or more processors coupled to the one or more non-transitory computer readable storage media and operable to execute the instructions to:
filter an audio signal into a plurality of frequency bands comprising a high-frequency band and a low-frequency band;
convert the audio signal in the high-frequency band to a target sound pressure;
convert the audio signal in the low-frequency band to a target speaker displacement;
predict, by a trained HF neural network and based on the target sound pressure corresponding to the audio signal in the high-frequency band, a first output voltage for a playing the audio signal by a loudspeaker;
predict, by a trained LF neural network and based on the target speaker displacement corresponding to the audio signal in the low-frequency band, a second output voltage for playing the audio signal by the loudspeaker; and
combine the first and second output voltages to obtain a final output voltage for playing the audio signal by the loudspeaker.

15. The system of claim 14, wherein the audio signal is filtered into the high-frequency band and the low-frequency band by a crossover filter.

16. The system of claim 14, wherein combining the first and second output voltages to obtain a final output voltage comprises summing the first and second output voltages.

17. The system of claim 14, wherein the loudspeaker comprises a speaker of a smartphone.

18. The system of claim 14, wherein the loudspeaker comprises a speaker of a headphone.

19. The system of claim 14, wherein the trained HF neural network is trained to predict ground-truth control voltages from input, recorded sound pressures caused by those ground-truth control voltages.

20. The system of claim 14, wherein the trained LF neural network is trained to predict ground-truth control voltages from input, recorded speaker displacements caused by those ground-truth control voltages.
